(19) United States
(12) Patent Application Publication
(10) Pub. No.: US 2011/0164823 A1
(43) Pub. Date: Jul. 7, 2011

(54) VIDEO OBJECT EXTRACTION APPARATUS AND METHOD

(75) Inventors: Chan Kyu Park, Daejeon (KR); Joo Chan Sohn, Daejeon (KR); Hyun Kyu Cho, Daejeon (KR); Young-Jo Cho, Daejeon (KR)

(73) Assignee: ELECTRONICS AND TELECOMMUNICATIONS RESEARCH INSTITUTE of Daejeon,Republic of Korea

(21) Appl. No.: 12/671,775

(22) PCT Filed: May 26, 2008
(86) PCT No.: PCT/KR2008/002926

§ 371 Date: Feb. 2, 2010

(30) Foreign Application Priority Data
Sep. 5, 2007 (KR) 10-2007-0089841

(51) Int. Cl. G06K 9/48

(52) U.S. Cl. 382/199

(57) ABSTRACT

A method of extracting a foreground object image from a video sequence includes producing a reference background image by separating a background image from a frame image of the video sequence; producing edge information of the frame image and the reference background image; producing an edge difference image using the edge information; and extracting the foreground object image using the edge difference image based on the edge information.

### TECHNICAL FIELD

The present invention claims priority of Korean Patent Application No. 10-2007-0089841, filed on Sep. 5, 2007, which is incorporated herein by reference.

The present invention relates to a technique for video object segmentation and, more particularly, to a video object extraction apparatus and method that is suitable for separating a background image and a foreground object image from a video sequence.

This work was supported by the IT R&D program of MIC/ITTA [2006-S-026-02, Development of the URC Server Framework for Proactive Robot Services].

### BACKGROUND ART

As known in the art, the Moving Picture Experts Group-4 (MPEG-4) standard for video compression has introduced new concepts such as object-based coding and video object plane (VOP), which were not present in the MPEG-1 or MPEG-2 standards. Under these concepts, a moving image to be compressed is regarded not as a set of pixels but as a set of objects that are present in different layers. Thus the objects are separately extracted to be coded.

Various image tracking techniques based on the VOP concept have been proposed to automatically track the objects in video sequences from infrared sensors or charge-coupled device (CCD) cameras using computer vision technology, for the purpose of application to automatic surveillance, video conferencing, and video distant learning.

For image tracking, background objects and foreground objects (or moving objects) are to be separately extracted. Such object extraction is performed mainly on the basis of background images or consecutive frames.

For extracting an object of interest from an image, an image segmentation is performed to divide the image into regions or segments for further processing, which can be performed based on features or edges. In a feature-based segmentation, the image is segmented into regions of pixels having a common feature. In an edge-based segmentation, edges are extracted from the image and meaningful regions in the image are segmented using the obtained edge information.

In particular, the edge-based segmentation searches for boundaries of regions, which is capable of extracting relatively accurate boundaries of regions. In the edge-based segmentation, however, it is necessary that that unnecessary edges are removed or broken edges are connected together in order to form meaningful regions.

In relation to separation and extraction of background objects and foreground objects, several prior art technologies are proposed. Among of them, there is a method and system for extracting moving objects, which discloses a procedure including the following steps: generating moving object edges using Canny edges of the current frame and initial moving object edges initialized through background change detection; generating moving object boundaries on the basis of the moving object edges; creating a first moving object mask by connecting broken ones of the moving object boundaries together; creating a second moving object mask by removing noise from the initial moving object edges through connected component processing and morphological operation; and extracting moving objects using the first and second moving object masks.

In addition, there is a smart video security system based on real-time behavior analysis and situation recognition to perform a moving object extraction procedure. The procedure includes the following steps: learning background including both static and dynamic objects using binomial distribution and hybrid Gaussian filtering; extracting pixels of the input image that are different from those of the background into a moving domain, and removing noise by applying a morphology filter; and extracting moving objects from the moving domain using adaptive background subtraction, moving averages of three frames, and temporal object layering.

Further another technology discloses a method for extracting moving objects from video images. The method includes the following steps: checking using a Gaussian mixture model whether the current pixel definitely falls within the background domain, and determining, if the current pixel does not definitely fall within the background domain, that the current pixel belongs to one of a shadow domain composed of plural regions, a highlight domain composed of plural regions, and a moving object domain.

These techniques for separating and extracting background objects and foreground objects apply a probabilistic operation or a probabilistic and statistical operation to a background modeling so as to restore information on broken boundaries of the objects or to cope with moving objects in the background. For example, methods such as differencing between the background image and the foreground image, mean subtraction using the background as the mean, and probabilistic and statistical means using Gaussian distributions have been proposed. However, in these techniques, if a foreground object while moving has a similar color to a background object, the foreground object may be recognized as the background object and be not extracted in its integrity, causing an error in the subsequent recognition process. Further, accuracy levels of these techniques are lowered under conditions such as changes in physical lighting or changes in the background object.

### DISCLOSURE OF INVENTION

### Technical Problem

It is, therefore, an object of the present invention to provide a video object extraction apparatus and method for extracting a foreground object having a color similar to that of a background object.

Another object of the present invention is to provide a video object extraction apparatus and method for separating foreground objects using multiple edge information of the background image and input image.

Yet another object of the present invention is to provide a video object extraction apparatus and method for capturing the movement of a foreground object having a color similar to that of the background through a scale transformation of an edge difference image to extract the boundary of the video object.

### Technical Solution

In accordance with an aspect of the present invention, there is provided a method of extracting a foreground object image from a video sequence, including: producing a reference background image by separating a background image from a frame image of the video sequence; producing edge information of the frame image and the reference background image; producing an edge difference image using the edge information; and extracting the foreground object image using the edge difference image based on the edge information.

In accordance with another aspect of the present invention, there is provided an apparatus of extracting foreground objects from a video sequence having a background scene, including: a background managing unit separating a background image from a frame image of the video sequence, and storing the background image as a reference background image; and a foreground object extractor producing an edge difference image using edge information of the frame image and the reference background image, and extracting a foreground image from the edge difference image based on the edge information.

### Advantageous Effects

According to the present invention, unlike a conventional method that separates and extracts foreground and background objects of the input image using operations including differencing, mean subtraction and probabilistic and statistical processing, an edge difference image is obtained using edge information and edge information of an input image and reference background object image, and the foreground object image is extracted by processing the edge difference image to remove the background object image and noise. As a result, the present invention is effectively applicable to video object extraction when the boundary of a video object has a color either different from or similar to that of the background.

In addition, the present invention can be used to extract a moving foreground object from a real-time video sequence, and be effectively applied to applications such as background object separation in computer vision, security surveillance, and robot movement monitoring.

### BRIEF DESCRIPTION OF THE DRAWINGS

The above and other objects and features of the present invention will become apparent from the following description of embodiments given in conjunction with the accompanying drawings, in which:

FIG. 1 is a block diagram of a video object extraction apparatus for extracting a foreground object image using multiple edge information in accordance with the present invention;

FIG. 2 is a detailed block diagram of a foreground object extractor shown in FIG. 1; and

FIG. 3 is a flow chart illustrating a video object extraction method for extracting a foreground object image using multiple edge information in accordance with the present invention.

### BEST MODE FOR CARRYING OUT THE INVENTION

Hereinafter, embodiments of the present invention will be described in detail with reference to the accompanying drawings so that they can be readily implemented by those skilled in the art.

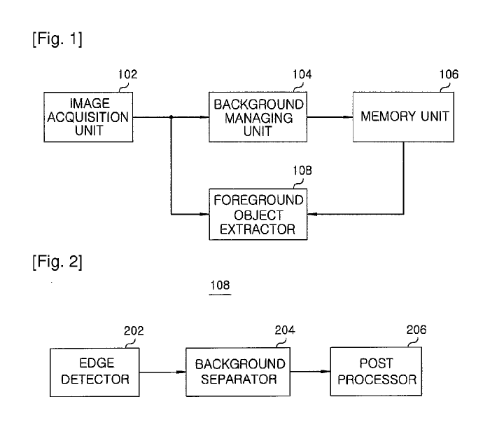

FIG. 1 is a block diagram of a video object extraction apparatus in accordance with to the present invention. The video object extraction apparatus of the present invention includes an image acquisition unit 102, a background managing unit 104, a memory unit 106, and a foreground object extractor 108.

The image acquisition unit 102 includes, for example, a charge-coupled device (CCD) camera or a complementary metal-oxide semiconductor (CMOS) camera, having a fixed viewing angle and placed at a fixed location, to acquire color video images of a target object in real time. In the CCD or CMOS camera, an optical signal corresponding to the color video image formed by the lens of a CCD module or CMOS module is converted into an electric imaging signal, which is then processed through exposure, gamma correction, gain adjustment, white balancing and color matrix metering, and converted through analog-to-digital conversion into a digital color video sequence. The digital video signal is then transmitted on a frame basis to the background managing unit 104. Further, the digital video sequence is forwarded on a frame basis to the foreground object extractor 108.

The background managing unit 104 functions to create, manage, and update the background of video images captured by the image acquisition unit 102. Thereto, the background managing unit 104 separates a background image from a current frame image utilizing statistical averaging according to a difference between the frame image and background image, and a hybrid Gaussian model including statistical estimation. The background image separated by the background managing unit 104 is stored in the memory unit 106 as a reference background image. When a foreground image is extracted from the frame image, the reference background image corresponding to the frame image is retrieved from the memory unit 106 and sent to the foreground object extractor 108.

The foreground object extractor 108 obtains edge information of the frame image and the reference background image, creates an edge difference image using the edge information, separates a background object image from the frame image on the basis of the edge information, and extracts a final foreground object image by removing noise from the background object image.

FIG. 2 is a detailed block diagram of the foreground object extractor 108 shown in FIG. 1. The foreground object extractor 108 includes an edge detector 202, a background separator 204, and a post processor 206.

The edge detector 202 performs preprocessing to obtain edge information of each the frame image and the reference background image. More specifically, the edge detector 202 transforms the reference background image and the frame image into a grayscale reference background image and a grayscale frame image, respectively. Because color information is unnecessary in an embodiment of the present invention, the use of the grayscale images can improve the speed of a foreground object extraction. Thereafter, the edge detector 202 primarily differentiates the grayscale reference background image and the grayscale frame image with respect to x- and y-axes to obtain primary edge information (dx, dy) of the grayscale reference background image and the grayscale frame image on each x-axis and y-axis component basis, respectively, wherein the edge information (dx, dy) indicates gradients in the x-axis and in the y-axis. The edge information of the reference background object image and the frame image contains only basic information. To extract the foreground object image similar to the background image in color, the edge detector 202 obtains a sum of differential values of the frame image on x- and y-axis components basis, Σ(dx1+dy1); and a sum of differential values of the reference background object image on x- and y-axis component basis, Σ(dx2+dy2). These sums of the differential values indicate the primary edge information of the frame image and the reference background image on x- and y-axes components basis, respectively. The edge information of the frame image and the reference background image obtained by the edge detector 202 is then transmitted to the background separator 204.

Here, ‘dx1’ and ‘dy1’ indicate respective x- and y-axes components wise primary edge information of the frame image; ‘dx2’ and ‘dy2’ indicate respective x- and y-axes wise edge information of the reference background image; and Σ(dx1+dy1) and Σ(dx2+dy2) indicate the edge information of the frame image and the reference background image on x- and y-axes basis, respectively.

The background separator 204 preserves edges of the foreground object in the frame image on the basis of edge information. Specifically, the background separator 204 calculates the difference Δdx between the differential values with respect to x-axis of the frame image and the reference background image, and the difference Δdy between the values of the differential values with respect to y-axis of the frame image and the reference background image. Thereafter, the background separator 204 sums the difference Δdx and the difference Δdy together to obtain the edge difference image Σ(Δdx+Δdy). The edge difference image is sent to the post processor 206. Here, the edge difference image is obtained by performing a subtraction operation on images having physical edge information. This subtraction operation enables the subtle difference between background and foreground objects that are similar each other and insensitive to variations in the light to be preserved as edges.

The edge difference image is still a grayscale image, and it is necessary to convert the edge difference image into a binary image for a foreground object extraction. It may be expected that the edge-extracted grayscale image has only pixels in the foreground object image after the subtraction between the foreground and background images. However, some pixels in the background image may still have edge information although its amount may be small. This deems a noise image.

The post processor 206 removes the reference background image and the noise image from the edge difference image through thresholding and scale transformation so that the foreground object image is extracted from the frame image. Specifically, the post processor 206 compares the edge information of the frame image Σ(dx1+dy1) with that of the reference background image Σ(dx2+dy2) in a pixel-wise manner to find pixels having a value greater than a preset reference value. The preset reference value is an empirically derived value. It is highly probable that the pixels having a value greater than the preset reference value belong to foreground objects, but the foreground object image may still contain noise.

Therefore, the post processor 206 performs thresholding the edge difference image using the pixels having a value greater than the preset reference value. The thresholded edge difference image is still not a binary image but a grayscale image. Finally, the post processor 206 scale-converts the edge difference image into a binary foreground image. Through the application of both thresholding and scale transformation, the foreground object image, obtained by removing the background image from the frame image, is filtered first, and then noise is removed from the foreground object image through the scale transformation. Scale transformation is performed using an empirically derived reference value of about 0.001-0.003, and the noise is scale-transformed into a value below the preset reference value. Consequently, the foreground object image is extracted by removing the background image and the noise from the frame image. Even if the foreground object image has the foreground objects therein similar to the background image in color, the foreground object image effectively preserves the shape of the foreground object.

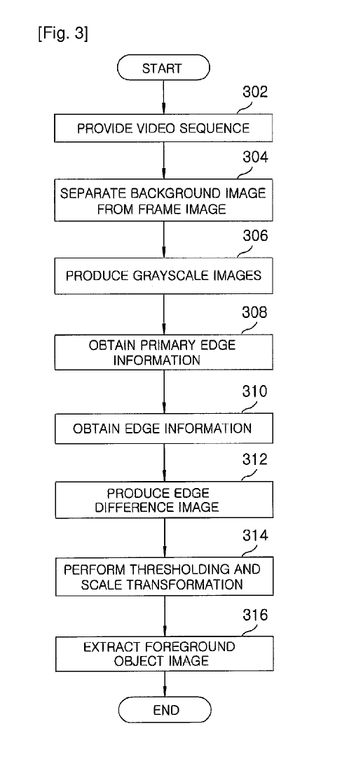

FIG. 3 is a flow chart illustrating a method for extracting a foreground object image in the video object extraction apparatus having an above-described configuration.

In step 302, a video sequence captured through the image acquisition unit 102 is provided to the background managing unit 104 and the foreground object extractor 108 on a frame basis.

In step 304, a background image is separated from the frame image by the background managing unit 104, and stored in the memory unit 106 as a reference background image.

In step 306, the frame image and the reference background image are scale-transformed, by the edge detector 202 of the foreground object extractor 108, into a grayscale frame image and a grayscale reference background object image, respectively.

In step 308, the grayscale frame image and the grayscale reference background object image are primarily differentiated by the edge detector 202 with respect to x-axis and y-axis, to thereby produce the primary edge information of the frame image and the reference background object image, respectively.

In step 310, the edge information of the frame image is produced by the edge detector 202 by summing differential values of the frame image in x-axis and y-axis; and edge information of the reference background image is produced by summing differential values of the reference background object image in x-axis and y-axis. The edge information of the frame image and reference background object image is transmitted to the background separator 204.

In step 312, the background separator 204 calculates the difference Δdx between the differential values with respect to x-axis of the frame image and the reference background object image, and the difference Δdy between the differential values with respect to y-axis of the frame image and the reference background object image, and calculates the summation the difference Δdx with respect to x-axis and the difference Δdy with respect to y-axis together to produce the edge difference image Σ(Δdx+Δdy). The edge difference image Σ(Δdx+Δdy) is then sent to the post processor 206.

In step 314, those pixels of the edge difference image having a value greater than or equal to the preset reference value are thresholded and scale-transformed by the post processor 206.

Finally, in step 316, a foreground object image free from background objects and noise is extracted through thresholding and scale transformation.

While the invention has been shown and described with respect to the preferred embodiments, it will be understood by those skilled in the art that various changes and modifications may be made without departing from the spirit and scope of the invention as defined in the following claims.

1. A method of extracting a foreground object image from a video sequence, comprising:
producing a reference background image by separating a background image from a frame image of the video sequence;
producing edge information of the frame image and the reference background image;
producing an edge difference image using the edge information; and
extracting the foreground object image using the edge difference image based on the edge information.

2. The method of claim 1, wherein the reference background image is updated with a new background image separated from a subsequent frame image.

3. The method of claim 1, wherein producing edge information comprises:
converting the frame image and the reference background image into a grayscale frame image and a grayscale reference background image, respectively;
producing primary edge information of each of the frame image and reference background object image by primarily differentiating the grayscale frame image and the grayscale reference background image; and
producing the edge information of the frame image and the reference background image by summing differential values of the frame image and the reference background image.

4. The method of claim 3, wherein the primary edge information of the frame image and reference background object image include gradient information in x-axis direction and y-axis direction, respectively.

5. The method of claim 4, wherein producing the edge difference image comprises:
calculating a difference between the differential values of the frame image and the reference background object image with respect to x-axis;
calculating a difference between the differential values of the frame image and the reference background object image with respect to y-axis; and
producing the edge difference image by summing the difference for x-axis and the difference for y-axis together.

6. The method of claim 1, wherein extracting a foreground object image comprises:
thresholding the edge difference image into a thresholded foreground object image; and
scale-transforming the thresholded foreground object image into the foreground object image with noise removal.

7. The method of claim 6, wherein thresholding the edge difference image comprises comparing the edge information of the frame image with that of the reference background image in x-axis and y-axis basis to find pixels having a value greater than a preset reference value, and wherein the edge difference image is thresholded using the pixels having a value greater than a preset reference value to thereby produce the thresholded foreground object image.

8. The method of claim 7, wherein scale-transforming the thresholded foreground object image comprises transforming the edge difference image into a binary image.

9. An apparatus of extracting foreground objects from a video sequence having a background scene, comprising:
a background managing unit separating a background image from a frame image of the video sequence, and storing the background image as a reference background image; and
a foreground object extractor producing an edge difference image using edge information of the frame image and the reference background image, and extracting a foreground image from the edge difference image based on the edge information.

10. The apparatus of claim 9, wherein the reference background image is updated with the background image in correspondence with the frame image continuously provided to the background managing unit.

11. The apparatus of claim 9, wherein the foreground object extractor comprises:
an edge detector producing edge information of the frame image and the reference background image;
a background separator producing the edge difference image using the edge information; and
a post processor extracting the foreground object image, freed from the background image and a noise image, from the edge difference image based on the edge information.

12. The apparatus of claim 11, wherein each of the frame image and reference background object image are transformed by the edge detector into a grayscale image.

13. The apparatus of claim 12, wherein the edge information of the frame image is produced by differentiating the frame image and the edge information of the reference background image is produced by differentiating the reference background image.

14. The apparatus of claim 13, wherein the edge information of the frame image and the reference background object image includes gradient information in x-axis direction and y-axis direction, respectively.

15. The apparatus of claim 13, wherein the edge information of the frame image and the reference background image are produced by summing differential values of the frame image and the reference background image.

16. The apparatus of claim 12, wherein the edge difference image is produced by calculating a difference between differential values of the frame image and the reference background object image with respect to x-axis, calculating a difference between differential values of the frame image and the reference background object image with respect to y-axis, and summing the difference with respect to x-axis and the difference with respect to y-axis together.

17. The apparatus of claim 12, wherein the post processor thresholds and scale-transforms the edge difference image to produce the foreground object image.

18. The apparatus of claim 17, wherein the post processor compares the edge information of the frame image with that of the reference background object image in x-axis and y-axis basis to find pixels having a value greater than a preset reference value related to the difference between the two pieces of the edge information, and thresholds the found pixels in the edge difference image.

19. The apparatus of claim 18, wherein the post processor scale-transforms the thresholded edge difference image into the foreground object image.
